(19) United States
(12) Patent Application Publication
(10) Pub. No.: US 2008/0078720 A1
(43) Pub. Date: Apr. 3, 2008

(54) System and Method for Removing Phosphorus From Non-Point Pollution Sources

(75) Inventors: Aleksandra Drizo, Bedford (CA); Hugo Picard, Bedford (CA)

Correspondence Address: DOWNS RACHLIN MARTIN PLLC, 199 MAIN STREET, P O BOX 190, BURLINGTON, VT, 05402-0190, US

(73) Assignee: The University of Vermont and State Agricultural College, Burlington, VT (US)

(21) Appl. No.: 11/862,765

(22) Filed: Sep. 27, 2007

Related U.S. Application Data
(60) Provisional application No. 60/848,438, filed on Sep. 29, 2006.

(51) Int. Cl. B01D 15/04; B01D 24/00; B01D 24/22

(52) U.S. Cl. 210/661; 210/282; 210/283; 210/291

(57) ABSTRACT

A modularized phosphorous filter (P-filter) for installing into open flow channels, such as urban and rural drainage ditches, streams, rivers, bayous, swales, etc. In some embodiments, the P-filter includes a module formed from a container that contains a phosphorous-filtering mass of loose pieces of slag. The container has anchoring extensions for anchoring the P-filter into the sides of the channel into which it is installed. In other embodiments, the P-filter is made of a number of P-filter modules each including a container that contains a phosphorous-filtering mass of loose pieces of slag. The P-filter modules are stacked with, and/or otherwise arranged relative to, one another so as to form a modularized P-filter. Preferably, the P-filter modules are sized to be readily movable by one or more people and/or power equipment, such as a tractor having a backhoe.

### RELATED APPLICATION DATA

This application claims the benefit of priority of U.S. Provisional Patent Application Ser. No. 60/848,438, filed Sep. 29, 2006, and titled “System and Method for Removing Phosphorous From Open-Channel Water Flow,” which is incorporated herein by reference in its entirety.

### FIELD OF THE INVENTION

The present invention generally relates to the field of water pollution treatment and control. In particular, the present invention is directed to a system and method for removing phosphorus from non-point pollution sources (diffuse pollution).

### BACKGROUND

Much effort has been expended in recent years removing from natural environments pollutants caused by manmade activities. For example, a common pollutant in many lakes, ponds, rivers, streams and other bodies of water and waterways is an overabundance of phosphorus. Excessive phosphorus originates from a number of sources, such as agricultural and residential fertilizers and detergents, and typically ends up in the natural environment via surface water runoff and direct and indirect discharge. Abnormally high phosphorus concentrations in bodies of water and waterways has a primary detrimental effect of causing excessive growth of algae and aquatic plants that often ultimately leads to eutrophication, which is a process by which a body becomes rich in nutrients and typically depleted in oxygen. Eutrophication caused by excessive algal and plant growth and their ultimate decomposition limits the use of surface waters for aesthetics, fisheries, recreation, industry and drinking, among other things.

### SUMMARY OF THE DISCLOSURE

In one embodiment, the present disclosure is directed to a filter for removing phosphorous from water. The filter includes a phosphorous-filtering mass of loose slag pieces having a pre-selected size distribution selected to allow water to flow through the mass. The filter further includes a container defining a cavity containing the phosphorous-filtering mass and having an upstream side, a downstream side spaced from the upstream side, a first end and a second end spaced from the first end, the container containing the phosphorous-filtering mass. The container includes a first sidewall located on the upstream side of the cavity and confronting the phosphorous-filtering mass. The first sidewall comprising a first screen having a plurality of first openings sized so that the container retains the phosphorous-filtering mass. A second sidewall is located on the downstream side of the cavity and confronts the phosphorous-filtering mass of the loose slag pieces. The second sidewall includes a second screen having a plurality of second openings sized so that the container retains the phosphorous-filtering mass. A first endwall is located proximate the first end and extends between the first sidewall and the second sidewall and confronts the phosphorous-filtering mass. The first endwall is configured so that the container retains the phosphorous-filtering mass. A second endwall is located proximate the second end and extends between the first sidewall and the second sidewall and confronts the phosphorous-filtering mass. The second endwall is configured so that the container retains the phosphorous-filtering mass. A bottom wall extends between the first endwall and the second endwall and the first sidewall and the second sidewall. The bottom confronts the phosphorous-filtering mass and is configured so that the container retains the phosphorous-filtering mass.

In another embodiment, the present disclosure is directed to a filter system for filtering phosphorous from flowing water. The filter includes a plurality of filter modules each including: an upstream permeable sidewall permeable to the flowing water; a downstream permeable sidewall permeable to the flowing water and spaced from the upstream permeable sidewall so as to partially define a cavity therebetween; and a phosphorous-filtering mass of loose slag substantially filling the cavity. The plurality of filter modules are arranged and engaged with one another so as to form a modular composite filter.

In a further embodiment, the present disclosure is directed to a method of reducing phosphorous in water flowing in an open channel and having a flow. The method includes providing a phosphorus filter comprising at least one filter module that includes: an upstream permeable sidewall permeable to the flowing water; a downstream permeable sidewall permeable to the flowing water and spaced from the upstream permeable sidewall so as to partially define a cavity therebetween; and a phosphorous-filtering mass of loose slag substantially filling the cavity. The phosphorous filter is installed in the open channel at a selected location so that substantially all of the flow passes through the phosphorus filter.

In yet another embodiment, the present disclosure is directed to a method of removing phosphorous from a body of water traversed by a bridge having a plurality of support piers spaced from one another so as to define at least one channel between adjacent ones of plurality of support piers. The method includes providing a plurality of phosphorus filter modules each comprising: an first permeable sidewall permeable to the flowing water; a second permeable sidewall permeable to the flowing water and spaced from the first permeable sidewall so as to partially define a cavity therebetween; and a phosphorous-filtering mass of loose slag substantially filling the cavity. The plurality of phosphorous filter modules are stacked within the at least one channel.

In still yet another embodiment, the present disclosure is directed to a method reducing phosphorous in surface water runoff from a farm having a drainage ditch each having a design water flow. The method includes providing at least one phosphorus filter that comprises: an upstream permeable sidewall permeable to the flowing water; a downstream permeable sidewall permeable to the flowing water and spaced from the upstream permeable sidewall so as to partially define a cavity therebetween; and a phosphorous-filtering mass of loose slag substantially filling the cavity. The at least one phosphorous filter is installed at a location in the drainage ditch so that substantially all of the design water flow flows through the phosphorus filter.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an isometric view of a phosphorus filter (P-filter) made in accordance with the present invention, shown empty;

FIG. 2A is a cross-sectional view as taken along line 2A-2A of FIG. 1, showing a mass of slag contained in the P-filter; FIG. 2B is a cross-sectional view as taken along line 2B-2B of FIG. 1, showing a mass of slag contained in the P-filter and partially depicting the P-filter in an earthen channel installation and a concrete channel installation;

FIG. 3 is a front elevation view of another P-filter made in accordance with the present invention that includes a removable upstream debris screen for inhibiting debris and other matter from flowing into the cavity of the P-filter;

FIG. 4 is an enlarged cross-sectional view as taken along line 4-4 of FIG. 3;

FIG. 5 is a partial cross-sectional view/partial front elevational view of a P-filter of the present invention in-situ in a water channel, wherein the P-filter includes a number of P-filter modules stacked with one another and a removable debris screen on the upstream side of the P-filter;

FIG. 6 is a plan view of a surface water channel containing three spaced P-filters each comprising a plurality of P-filter modules;

FIG. 7 is a partial elevational view/partial cross-sectional view of a bridge spanning a waterway in which a plurality of P-filters are placed in relation to the bridge; and

FIG. 8 is a transverse cross-sectional view of a P-filter module made in accordance with the present invention that includes a suspended-solids pre-filter on the upstream side of the P-filter module.

### DETAILED DESCRIPTION

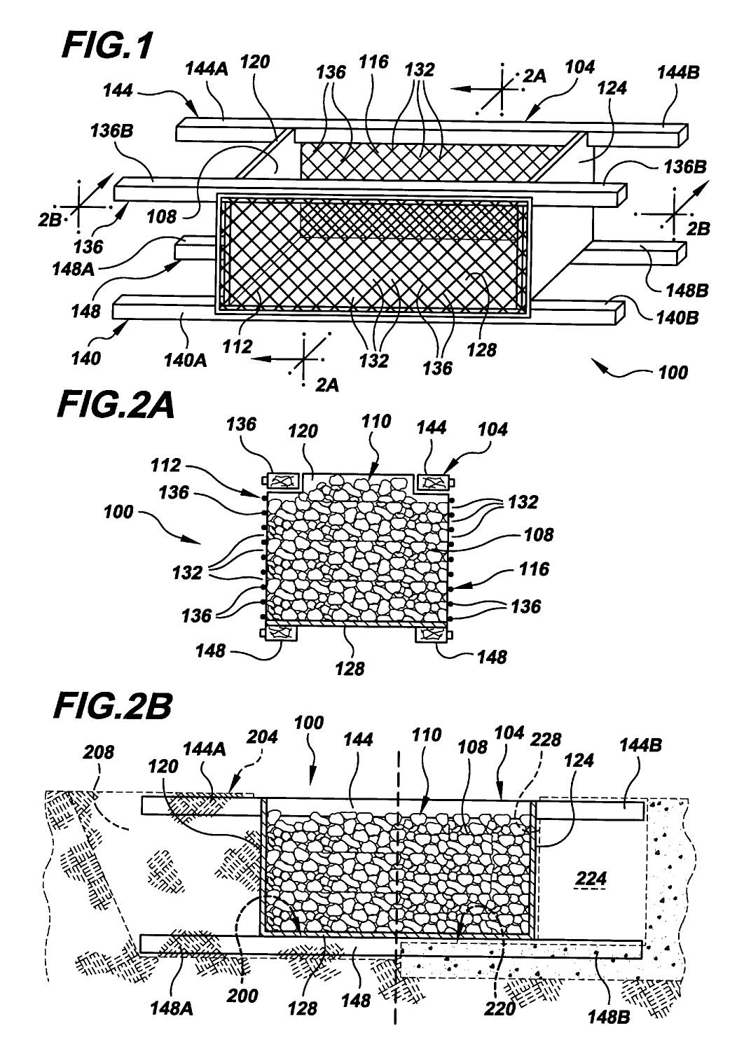

Referring to the drawings, FIGS. 1, 2A and 2B illustrate an example 100 of a phosphorous filter (P-filter) made in accordance with the present invention. P-filter 100 includes a container 104 that defines a cavity 108, which may be partially or completely filled with a mass 110 of loose pieces of slag, for example, crushed or palletized, or other material having the ability to remove phosphorous from a liquid (not shown), such as impure water, flowing through the filter. As described below, a P-filter of the present disclosure, such as P-filter 100, can be used in any of a variety of locations, for example, at locations where the unwanted phosphorous enters the liquid via non-point sources, but also at locations corresponding to point sources as well. Examples of suitable locations include storm water drains in urban areas (buildings and parking lots), or drainage ditches on farms, for example, in/around fields or near animal feeding or milking operations, streams, rivers, lakes, swales, or another type of channel, regardless of whether the channel carries residential, farm, industrial, or other runoff or flow containing unwanted phosphorous.

Various types of slag, for example, slag from a steelmaking process, are known to have the ability to absorb a substantial amount of phosphorous. The present inventors have found electric arc furnace steel slag to have very favorable phosphorous filtering properties in the context of a P-filter of the present disclosure. That said, other slag types can be used in a phosphorous filter made in accordance with the present invention. The size of the slag pieces may be any size suitable for a particular application. In one embodiment, wherein the volume of mass 110 of loose slag is on the order of several cubic feet to tens of cubic feet, the present inventors have found that slag piece sizes of 0.5 inch to several inches work well. This, of course, does not necessarily preclude other sizes from use. In one particular example, about 100% of the pieces are greater than 10 mm and about 80% of the pieces are greater than about 20 mm. Those skilled in the art will appreciate that in other embodiments, the pieces may be of other sizes and other size distributions.

When steelmaking slag is used, a P-filter of the present disclosure, for example, P-filter 100 of FIGS. 1, 2A and 2B, removes phosphorous by specific absorption on metal hydroxides and calcium phosphate precipitation via the slag and by bacterial uptake at specific hydraulic retention times. Such a P-filter is inexpensive, has minimal land requirements, no energy needs, flexibility in installation, high efficiency (e.g., can remove about 40% to about 90% of phosphorous and about 40% to about 80% of suspended solids from agricultural runoff (e.g., farm ditches, drainage tiles, culverts, and manure leachate) containing various concentrations of phosphorous (from as low as 0.1 mg/L up to 100 mg/L). In addition, such a P-filter provides a long-term solution for phosphorous removal via slag regeneration, and the used slag has potential to be reused as a fertilizer or a soil amendment, for example, in acid mine restoration, among other situations. A P-filter of the present disclosure is also readily adaptable to existing drainage and treatment systems. Details of several embodiments of a P-filter of the present disclosure are provided below.

Referring still to FIGS. 1, 2A and 2B, at a high level, container 104 is configured to allow the liquid from which phosphorous is being removed by P-filter 100 to flow through the filter. In the example shown, container 104 includes an upstream sidewall 112, a downstream sidewall 116, two endwalls 120, 124 and a bottom wall 128 that together define cavity 108. It is noted that in some applications a top wall (not shown) may be provided to enclose cavity 108. In an embodiment in which the flow of liquid is essentially straight through the P-filter, which occurs with P-filter 100, each of sidewalls 112, 116 includes a plurality of openings 132 sized for the flow and to inhibit the pieces of slag from passing therethrough to the outside of container 104. In this connection, each sidewall 112, 116 may have an open-to-solid ratio suitable for the design flow through container 104 and to not allow excessive deflection of that sidewall.

Deflection of each sidewall 112, 116 typically occurs as a result of the lateral pressure applied by the mass of the slag against that sidewall, as well as the force resulting from the flow of liquid striking and passing through P-filter. In one example, it may be appropriate to make each of openings 132 at least 0.25 inch². In another example, it may be appropriate to make openings 132 on the order of 1 inch² each. In either of these examples, the widths of the solids 136 of each sidewall 112, 116 may be any suitable value, such as 0.25 inch or greater. Of course, in other examples, for example, embodiments wherein solids 136 of sidewalls 112, 116 include very heavy gage woven wire and the sizes of opening 132 are relatively small and/or other design considerations allow, for example, low sidewall height and low-head flow, the widths of the solids may be less than 0.25 inch. Upstream and downstream sidewalls 112, 116 may each be made of any suitable material, such as metal or plastic, among others. For the sake of convenience, regardless of the type of construction of sidewalls 112, 116, i.e., regardless of whether sidewalls are made of woven wire or a plate having openings 132 formed (e.g., cut, punched, etc.), the sidewalls are referred to herein and in the appended claims as being “screens” to denote their multi-fenestrated character.

As those skilled in the art will readily appreciate, sidewalls 112, 116 may be of any areal dimensions suitable for a particular application. For the sake of illustration, but not limitation, each sidewall 112, 116 may have a height of less than 8 inches to several feet or more. The length of each sidewall 112, 116 may range from two feet or less, up to 20 feet or more, again, depending upon a particular application. In one example, a goal of sizing P-filter 100 is to allow container 104 or completed P-filter (i.e., filled with slag) to be handled either manually by one or several workers or with the aid of relatively light equipment, such as a farm tractor having a front-end loader and/or backhoe, among other things.

Like upstream and downstream sidewalls 112, 116, endwalls 120, 124 and bottom wall 128 are typically provided to contain the mass of slag in cavity 108 of the container 104. However, endwalls 120, 124 and bottom wall 128 may also be configured to channel the flow of the liquid flowing through P-filter through downstream sidewall 116. Consequently, each of the endwalls 120, 124 and bottom wall 128 may be either solid to block flow therethrough, or apertured to allow flow therethrough. An example of a design in which it is desirable to block flow through the bottom wall 128 and/or one, the other, or both endwalls 120, 124 is when the corresponding one(s) of these walls is/are in contact with soil or other readily erodable material. On the other hand, an example of a design in which it may be desirable that one or more of endwalls 120, 124 and bottom wall 128 permit flow is when P-filter 100 is stacked on another similar P-filter and such wall(s) is/are not in contact with a readily erodable material. Of course, even if one or more of endwalls 120, 124 and bottom wall 128 are not going to be in contact with a readily erodable material, such wall(s) may be made solid.

A design consideration for all of walls 112, 116, 120, 124, 128, especially for bottom wall 128 when cavity 104 is filled with mass 110 of slag and P-filter 100 is being lifted or carried without bottom support, is the required strength. For example, if P-filter 100 is designed to be movable without bottom support while cavity 104 is filled with mass 110 of slag, bottom wall 128, endwalls 120, 124 and sidewalls 112, 116 must be able to support the slag without any intra-span support, unless stiffeners (not shown) are provided. On the other hand, if container 104 is designed to be filled in-situ only after the container has been located in a desired location, then the appropriate ones of side and bottom walls 120, 124, 128 may be considered to have intra-span support and, therefore, need not be so robust. Suitable materials for endwalls 120,124 and bottom wall 128 include metal, plastic, wood, and concrete, among others.

As mentioned above, although not shown, slag container 104 of P-filter 100 may also include a top wall, which also may be either solid or apertured depending on design criteria and/or goals. Such top wall may also be made of any suitable material.

The various walls 112, 116, 120, 124, 128 (and top wall, if provided) of container 104 may be connected to one another and/or to any suitable framing in any manner that provides the necessary structural integrity to P-filter 100. In the embodiment shown in FIG. 1, each of sidewalls 112, 116 and bottom wall 128 are suitably secured to four elongate members 136, 140, 144, 148 therealong. Endwalls 120, 124 may also be connected to these members 136, 140, 144, 148 and/or to sidewalls 112, 116, bottom wall 128 or other framing members (not shown). In one example, framing members 136, 140, 144, 148 are made of pressure treated wood, for example, 4″×4,″ 6″×6,″ etc., dimensional lumber. In other examples, framing members 136, 140, 144, 148, may be made of another material, such as metal. In other embodiments, framing members 136, 140, 144, 148 may not be provided. In some of these alternative embodiments, the various walls may be connected directly to one another and/or connected together via one or more other types of connecting members, such as brackets, among others.

In the embodiment shown in FIG. 1, framing members 136, 140, 144, 148 are extended beyond endwalls 120, 124 to allow for installation in a flow channel having sidewalls suitable for anchoring P-filter 100 against the force of the flow of liquid within the channel. The portions of the framing members 136, 140, 144, 148 beyond endwalls 120, 124, and therefore beyond container 104 for anchoring P-filter 100 in a flow channel (see, e.g., flow channels 200, 220 of FIG. 2B), may be considered “extension members” 136A-B, 140A-B, 144A-B, 148A-B relative to the container. Those skilled in the art will readily appreciate that extension members 136A-B, 140A-B, 144A-B, 148A-B need not necessarily be integral extensions of elongate members 136, 140, 144, 148, but rather may be separate members suitably attached to container 104. In addition, extension members 136A-B, 140A-B, 144A-B, 148A-B may be provided at locations other than each of the end corners of the container and may have a different form than shown. For example, extension members alternative to extension members 136A-B, 140A-B, 144A-B, 148A-B shown may be provided only on the upstream side of the P-filter, only on the downstream side or somewhere in between. In addition, the form of the extensions may be, e.g., a vertical or horizontal I-shaped section, among many other forms.

One type of flow channel into which a P-filter of the present disclosure, such as P-filter 100 of FIG. 1, may be installed is a simple earthen drainage ditch 200 as depicted on the left side of FIG. 2B. In this type of installation, extension members 136A-B, 140A-B, 144A-B, 148A-B will typically be buried or embedded in the earthen banks/sides 204 of ditch 200. However, more sophisticated measures may be taken if necessary to provide the earthen banks/sides and/or bottom of the ditch with additional resistance to flow. For example, different fill material 208 and/or cutoff walls (not shown) may be used. Another type of flow channel into which a P-filter of the present disclosure, such as P-filter 100, may be installed is a preformed concrete channel 220, as depicted on the right side of FIG. 2B. Such channel 220 may be provided with vertical grooves 224 or other cavities in the sidewalls 228 to accept any extension members present on the P-filter, here extension members 136A-B, 140A-B, 144A-B, 148A-B. Those skilled in the art will recognize the variety of flow channels and channel constructions with which a P-filter of the present disclosure may be used.

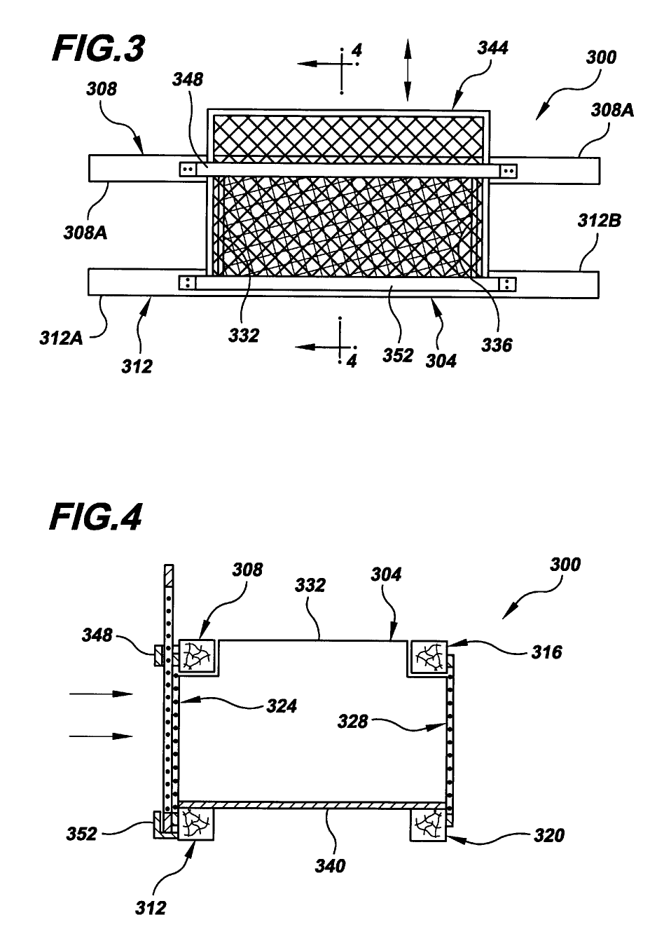

FIGS. 3 and 4 illustrate another P-filter 300 made in accordance with the present invention. For the sake of illustrating the construction of P-filter 300 it is shown empty, that is, without slag. However, it should be understood that when in use, P-filter 300 would contain a suitable mass phosphorous-absorbing slag, such as mass 110 of slag described above in connection with FIGS. 1-2B. Like P-filter 100 of FIGS. 1-2B, P-filter 300 of FIGS. 3 and 4 includes a container 304 for containing a mass of slag (not shown) for the same reasons as described above relative to P-filter 100. In this example, container 304 includes four elongate frame members 308, 312, 316, 320 having corresponding respective anchoring members (only extension members 308A-B, 312A-B are shown). Container 304 also includes sidewalls 324, 328, endwalls 332, 336 and a bottom wall 340 suitably secured to frame members 308, 312, 316, 320. In this example, each sidewall 324, 328 is made of a mesh panel, for example, metal, or other screen, and each of endwalls 332, 336 and bottom wall 340 is made of a solid panel, for example, metal.

Unlike P-filter 100 of FIGS. 1-2B, P-filter 300 of FIG. 3 further includes a debris screen 344 on the upstream side of container 304. Debris screen 344 would typically be desirable when P-filter 300 is installed in a flow channel (not shown) that carries an amount of debris that can clog the mass of slag within the P-filter, or even clog the openings of upstream sidewall 324, thereby reducing the effectiveness of the P-filter. Debris screen 344 may be made readily removable, for example, by providing suitable support structure, such as the upper and lower supports 348, 352 shown. In this embodiment, upper support 348 is simply a bar formed to provide a space for debris screen 344 between itself and frame member 308. Lower support member 352 has a generally L-shaped transverse cross-section so as to provide debris screen 344 with vertical support and a space that captures the lower end of the debris screen. In alternative embodiments, the support structure for debris screen 344 may take a different form, such as vertical channel members on either side of debris screen 344 that allow the screen to be slid up and down for removal and replacement. In some installations, debris screen 344 would be provided with openings smaller than the openings in the upstream sidewall 308. In this case, the primary purpose of debris screen 344 would be to block debris that would otherwise tend to clog the mass of loose slag from entering P-filter 300.

In other installations, debris screen 344 would be provided with openings larger than the openings in upstream sidewall 308. In this case the primary purpose of debris screen 344 would be to allow large pieces of debris to be easily periodically removed by removing, cleaning and replacing the debris screen. In the context of removing large debris, it may be desirable to use side vertical channel supports to hold debris screen 344 so that upper support 348 shown does not interfere with the debris captured on the debris screen. In the embodiment shown in FIGS. 3 and 4, debris screen 344 extends above the top of container 304. This may be done for several reasons, such as to allow a user to readily grasp debris screen 344 and to allow a second P-filter (not shown) to be stacked on top of P-filter 300 shown for channels that are deep enough to require two filters. In the latter case, making debris screen 344 the height of two P-filters (or higher) circumvents the need for separate debris screens for the stacked filters. This is beneficial, especially when the lower P-filter is submerged so that it would make it inconvenient to remove and clean the lower debris screen.

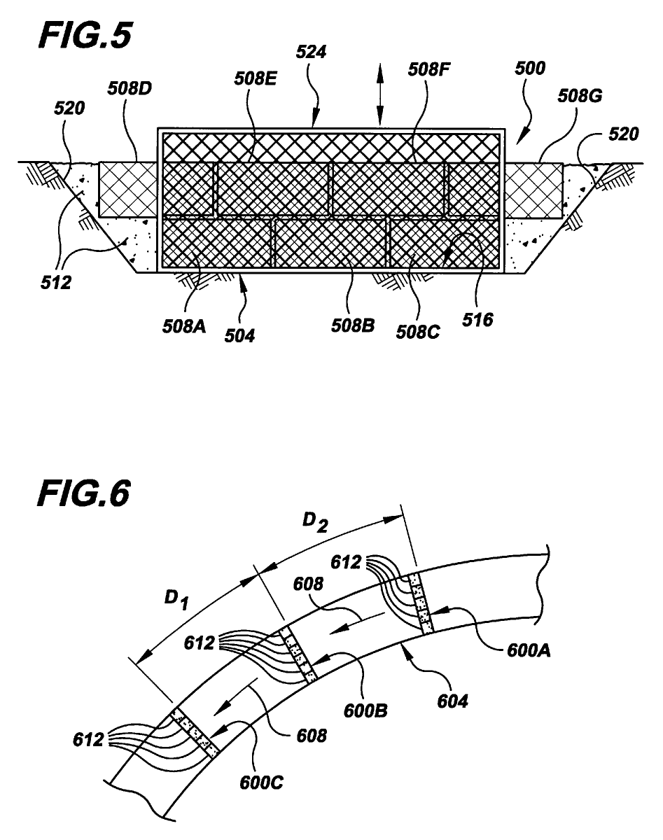

FIG. 5 illustrates another P-filter made 500 in accordance with the present invention. In this example, P-filter 500 is installed in an open earthen flow channel 504. P-filter 500 is a composite filter that comprises a plurality of filter modules 508A-G, each of which may be constructed in a manner similar to P-filters 100, 300 of FIGS. 1-4. A suitable fill material 512 is provided to fill the gaps between P-filter 500 and the bed 516 and banks 520 of channel 504 and/or the regions excavated to install the filter. Each filter module 508A-G may be made to stack and/or interlock with other like modules in any of a variety of ways. For example, filter modules 508A-G may be provided with corresponding respective mortises and tenons (not shown) that closely and conformally engage one another. In other embodiments, interlocking structures may not be needed, particularly in low channel flow velocity conditions. In yet other embodiments, immediately adjacent filter modules may be fastened together using any of a wide variety of fasteners (not shown), for example, bolts, screws, nails, etc., and fastening devices, for example, brackets, latches, hooks and eyes, etc.

Filter modules 508A-G may be stacked in any single- or multiple-width arrangement using any suitable bond pattern, such as running bond (a.k.a. stretcher bond), English bond, Flemish bond, or garden wall bond, among others. In addition, while individual filter modules 508A-G are shown as being the same size as one another, in other implementations the modules may be made different sizes to suit particular applications. Furthermore, some of filter modules 508A-G, for example, end modules 508A, 508C, 508D, 508G, may be provided with anchoring extension members on one end, for example, in the same manner as P-filters 100, 300 of FIGS. 1-4. If desired, composite filter 500 may be provided with one or more removable debris screens, such as debris screen 524, for example in the same manner as debris screen 344 of FIGS. 3 and 4. FIG. 5 illustrates single large debris screen 524 that is held in place largely only by the force of the water (not shown) impacting upon P-filter 500. Alternative embodiments may include a series of narrower debris screen panels (not shown). In such an example, the multiple debris screen panels may slidably engage corresponding respective vertical channels that allow the individual panels to be independently slid up and down for removal and replacement.

FIG. 6 illustrates a plurality of P-filters 600A-C placed in a channel 604 in series with one another and spaced by distances D1, D2. For example, spaced P-filters 600A-C may be used to provide a stepwise reduction in the phosphorous content of the flow of liquid (represented by arrows 608) in channel 604 and/or to remove phosphorous that enters the channel at various points upstream of and between the multiple P-filters. In this example, each P-filter 600A-C is made of multiple P-filter modules 612 in the same manner as P-filter 500 of FIG. 5. Indeed, each P-filter module 612 may be constructed as described above in connection with P-filter module 508A-G. Although P-filters 600A-C are illustrated as being composite filters in FIG. 6, if the installation is suitable, each of the P-filters may be a single filter, such as either one of P-filters of FIGS. 1-4. Of course, more or fewer than three spaced P-filters may be provided in any given channel or system of channels. As a practical example, multiple spaced P-filters may be used in drainage ditch networks in farm fields to filter the non-point runoff from the fields.

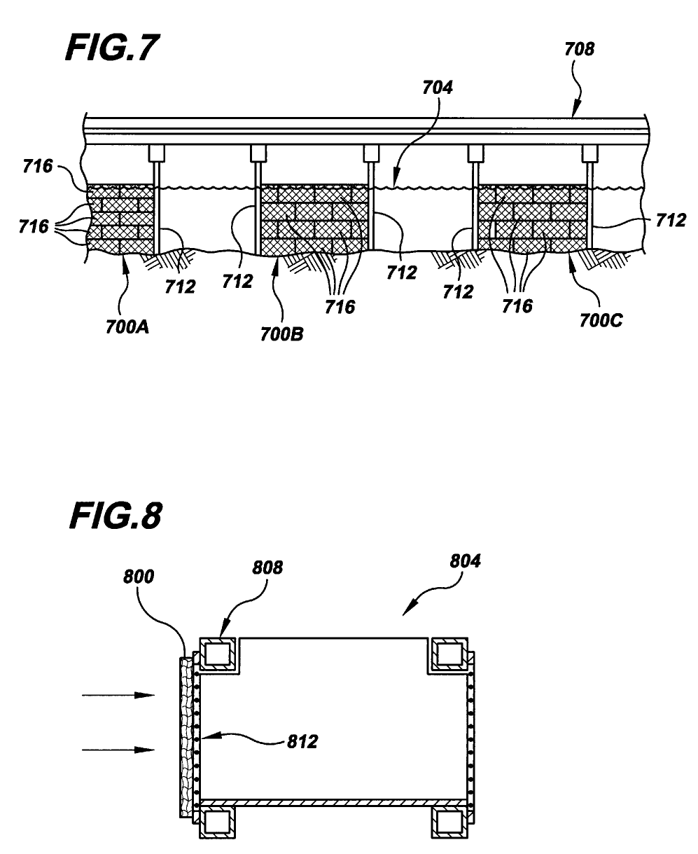

FIG. 7 illustrates the use of a number of P-filters 700A-C of the present disclosure in the context of filtering phosphorous from a body of water 704, for example, a lake, river, bayou, bay, etc., traversed by a bridge 708 having a number of support piers 712. In the embodiment shown, each filter 700A-C is composed of a plurality of P-filter modules 716 stacked with one another in alternating spaces between adjacent sets of support piers 712. In this example, body of water 704 contains aquatic animals (not shown), so all of the spaces between adjacent piers are intentionally not blocked with P-filters to allow the aquatic animals to move freely in the water from one lateral side of bridge 708 to the other. In other installations, all of the spaces between the adjacent piers 712 and any spaces between the shore (not shown) and a pier may be filled with phosphorous filters. Each P-filter 700A-C may be similar to composite P-filters 500, 600 described above in connection with FIGS. 5 and 6. As an alternative to placing P-filters, such as P-filters 700A-C in fewer than all spaces between piers 712 and shores to allow for movement of aquatic animals in the water, each space between adjacent piers 712 may be partially blocked with P-filters, such as stacking P-filter modules one either side of each pier so to flank each pier with two pillared P-filters. These pillared P-filters would have widths along the length of bridge 708 less than one-half of the pier spacing, for example, one-third of such spacing, so as to leave open space between adjacent pillared P-filters. One, some, or all of the spaces between piers 712 may contain such an arrangement of filter modules. Those skilled in the art will readily appreciate that the arrangements shown and described in connection with FIG. 7 are illustrative and by no means limiting.

If a particular P-filter installation is subject to a flow having anticipated significant suspended solids, each filter or filter module may be provided with a suitable suspended-solids filter. FIG. 8 illustrates a sheet type of suspended-solids filter 800 that may be incorporated in a filter or filter module 804, which may be, for example, any one of the filters 100, 300 and filter modules 500 described above in connection with FIGS. 1-5. In this example, suspended-solids filter 800 comprises a filter material, such as polyester or polyacrylamide, among others. A suspended-solids filter suitable for use as filter 800 is described in detail in U.S. Pat. No. 5,178,773 to Kerlin et al. and titled “High-Efficiency Filter To Remove Suspended Solids From Aqueous Media,” which is incorporated herein for it disclosure of suspended solids filtering and filters. Suspended-solids filter 800 may be secured to container 808 of phosphorous filter 804 in any suitable manner, such as ties (not shown) to the screen of sidewall 812 or providing the suspended-solids filter with a frame not shown that may be, for example, engaged with and slidable within vertical channels affixed to the container. In alternative embodiments, suspended-solids filter 800 may be made using suspended-solids brushes having bristles made of polyacrylamide or other material suitable for filtering suspended solids from water. In some embodiments, a plurality of such brushes may be placed in a space between the upstream sidewall of the P-filter (or module) container and a debris screen. See FIG. 4, for example. Similarly, in embodiments, sheet type suspended-solids filter 800 of FIG. 8 may be installed between the upstream sidewall of the P-filter (or module) container and a debris screen secured to the container upstream of the upstream sidewall of the container.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A filter for removing phosphorous from water, comprising:
a phosphorous-filtering mass of loose slag pieces having a pre-selected size distribution selected to allow water to flow through said mass; and
a container defining a cavity containing said phosphorous-filtering mass and having an upstream side, a downstream side spaced from said upstream side, a first end and a second end spaced from said first end, said container containing said phosphorous-filtering mass and including:
a first sidewall located on said upstream side of said cavity and confronting said phosphorous-filtering mass, said first sidewall comprising a first screen having a plurality of first openings sized so that said container retains said phosphorous-filtering mass;
a second sidewall located on said downstream side of said cavity and confronting said phosphorous-filtering mass of said loose slag pieces, said second sidewall comprising a second screen having a plurality of second openings sized so that said container retains said phosphorous-filtering mass;
a first endwall located proximate said first end and extending between said first sidewall and said second sidewall and confronting said phosphorous-filtering mass, said first endwall configured so that said container retains said phosphorous-filtering mass;
a second endwall located proximate said second end and extending between said first sidewall and said second sidewall and confronting said phosphorous-filtering mass, said second endwall configured so that said container retains said phosphorous-filtering mass; and
a bottom wall extending between said first endwall and said second endwall and said first sidewall and said second sidewall, said bottom confronting said phosphorous-filtering mass and configured so that said container retains said phosphorous-filtering mass.

2. A filter according to claim 1, wherein each of said bottom wall, said first endwall and said second endwall is solid.

3. A filter according to claim 1, wherein substantially all of said loose slag pieces have a size in a range of about 10 mm to about 50 mm.

4. A filter according to claim 3, wherein about 80% of said loose slag pieces have a size in a range of about 20 mm to about 30 mm and about 20% of said loose slag pieces have a size in a range of about 10 mm to about 20 mm.

5. A filter according to claim 1, wherein each of said first screen and said second screen has an openings-to-solids areal ratio of at least 1:1, each opening of said plurality of first openings and said plurality of second openings having an average opening area of at least about 160 mm².

6. A filter according to claim 1, wherein each opening of said plurality of first openings and said plurality of openings have an average opening area of at least about 500 mm².

7. A filter according to claim 1, further comprising a debris screen removably secured to said container on said upstream side adjacent said first screen opposite said phosphorous-filtering mass.

8. A filter according to claim 1, further comprising a suspended-solids filter located proximate said upstream side of said container.

9. A filter according to claim 8, further comprising a debris screen secured to said container on said upstream side of said container, said suspended-solids filter located between said first screen and said debris screen.

10. A filter according to claim 1, wherein the filter is adapted for use in a channel having a first channel sidewall and a second channel sidewall spaced from the first channel sidewall, the filter further comprising:
at least one first anchoring extension secured to said container and extending away from said container beyond said first endwall for anchoring the filter in said first channel sidewall; and
at least one second anchoring extension secured to said container and extending away from said container beyond said second endwall for anchoring the filter in said second channel sidewall.

11. A filter according to claim 1, wherein said mass of said loose slag substantially fills said cavity and said mass of slag has a weight of less than about 2,268 kg.

12. A filter according to claim 1, wherein said phosphorus removal efficiency is at least 80% for the flow.

13. A filter system for filtering phosphorous from flowing water, comprising:
a plurality of filter modules each including:
an upstream permeable sidewall permeable to the flowing water;
a downstream permeable sidewall permeable to the flowing water and spaced from said upstream permeable sidewall so as to partially define a cavity therebetween; and
a phosphorous-filtering mass of loose slag substantially filling said cavity;
wherein said plurality of filter modules are arranged and engaged with one another so as to form a modular composite filter.

14. A filter system according to claim 13, wherein said modular composite filter includes ones of said plurality of filter modules stacked with one another so that each said upstream permeable sidewall lies substantially in a common plane.

15. A filter system according to claim 13, further including at least one removable debris filter located proximate said upstream permeable sidewall of at least some of said plurality of filter modules.

16. A method of reducing phosphorous in water flowing in an open channel and having a flow, the method comprising:
providing a phosphorus filter comprising at least one filter module that includes:
an upstream permeable sidewall permeable to the flowing water;
a downstream permeable sidewall permeable to the flowing water and spaced from the upstream permeable sidewall so as to partially define a cavity therebetween; and
a phosphorous-filtering mass of loose slag substantially filling the cavity; and
installing the phosphorous filter in the open channel at a selected location so that substantially all of the flow passes through the phosphorus filter.

17. A method according to claim 16, further comprising installing a removable debris screen adjacent the upstream permeable sidewall opposite the mass of the loose slag.

18. A method according to claim 16, further comprising installing a suspended-solids filter adjacent the upstream permeable sidewall.

19. A method according to claim 16, wherein said providing of the phosphorus filter includes providing a filter module that includes at least one anchoring extension member and said installing of the phosphorous filter includes engaging the at least one anchoring extension member into at least one sidewall of the open channel.

20. A method according to claim 16, wherein said providing of the phosphorous filter comprises
providing a plurality of filter modules each including:
an upstream permeable sidewall permeable to the flowing water;
a downstream permeable sidewall permeable to the flowing water and spaced from said upstream permeable sidewall so as to partially define a cavity therebetween; and
a phosphorous-filtering mass of loose slag substantially filling said cavity;
wherein said installing of the phosphorus filter includes arranging said plurality of filter modules relative to one another within the channel so that the flow flows through the phosphorus filter.

21. A method according to claim 20, wherein said installing of the phosphorus filter comprises stacking at least one of the plurality of filter modules on top of another one of the plurality of filter modules.

22. A method according to claim 16, wherein the channel has a length and the method includes:
providing a plurality of phosphorous filters that each comprises:
an upstream permeable sidewall permeable to the flowing water;
a downstream permeable sidewall permeable to the flowing water and spaced from the upstream permeable sidewall so as to partially define a cavity therebetween; and
a phosphorous-filtering mass of loose slag substantially filling the cavity;
selecting a plurality of location in the channel spaced from one another along the length of the channel for corresponding respective ones of said plurality of phosphorous filters; and
installing ones of the plurality of phosphorous filters in the channel at corresponding differing locations along the length so that the flow flows through each of the plurality of phosphorus filters.

23. A method of removing phosphorous from a body of water traversed by a bridge having a plurality of support piers spaced from one another so as to define at least one channel between adjacent ones of plurality of support piers, the method comprising:
providing a plurality of phosphorus filter modules each comprising:
an first permeable sidewall permeable to the flowing water;
a second permeable sidewall permeable to the flowing water and spaced from the first permeable sidewall so as to partially define a cavity therebetween; and
a phosphorous-filtering mass of loose slag substantially filling the cavity; and
stacking the plurality of phosphorous filter modules within the at least one channel.

24. A method according to claim 23, wherein the bridge has a first lateral side and a second lateral side and said stacking of the plurality of phosphorous filter modules comprises arranging said plurality of phosphorous filter modules to provide a passageway for subsurface aquatic animals to traverse the bridge from the first lateral side to the second lateral side within the body of water.

25. A method reducing phosphorous in surface water runoff from a farm having a drainage ditch each having a design water flow, comprising:
providing at least one phosphorus filter that comprises:
an upstream permeable sidewall permeable to the flowing water;
a downstream permeable sidewall permeable to the flowing water and spaced from the upstream permeable sidewall so as to partially define a cavity therebetween; and
a phosphorous-filtering mass of loose slag substantially filling the cavity; and
installing the at least one phosphorous filter at a location in the drainage ditch so that substantially all of the design water flow flows through the phosphorus filter.
